(19) United States
(12) Patent Application Publication
(10) Pub. No.: US 2023/0371418 A1
(43) Pub. Date: Nov. 23, 2023

(54) DRY LAND-BASED SEED WATER-RETENTION SOWING METHOD

(71) Applicant: SHANXI INSTITUTE OF ORGANIC DRYLAND FARMING, SHANXI AGRICULTURAL UNIVERSITY, Taiyuan (CN)

(72) Inventors: Xiaojuan WANG, Taiyuan (CN); Juanling WANG, Taiyuan (CN)

(21) Appl. No.: 18/315,547

(22) Filed: May 11, 2023

Related U.S. Application Data
(63) Continuation of application No. PCT/CN2022/139794, filed on Dec. 16, 2022.

(30) Foreign Application Priority Data
May 19, 2022 (CN) 202210543982.3

(51) Int. Cl. A01C 1/04

(52) U.S. Cl. CPC A01C 1/044

(57) ABSTRACT

The present invention relates to a dry land-based seed water-retention sowing method, belonging to the technical field of seed sowing; the method specifically includes steps of: forming water-retention sleeves by double non-woven fabrics and a polyacrylamide water-retaining agent disposed between the double non-woven fabrics, and placing seeds into the water-retention sleeves, and finally placing the seeds with the water-retention sleeves into water for soaking and sowing the seeds. In this way, the present invention can effectively relieve the dependence of crop seed sowing on soil moisture. Therefore, the present invention is suitable for dry land sowing and can improve the seedling emergence rate of seeds.

### FIELD OF TECHNOLOGY

The present invention relates to a dry land-based seed water-retention sowing method, belonging to the technical field of seed sowing.

### BACKGROUND

Currently, because there is shortage of watering conditions during dry land planting due to drought, most of crop seeds cannot be sown in normal sowing seasons to miss farming seasons, thus affecting the maturity and yield of crops. Even though seeds are sown forcedly, most of seeds are incapable of achieving seedling emergence, which affects the sowing quality, crop yield and peasant income seriously.

### SUMMARY

To solve the technical problem existing in the prior art, the present invention provides a dry land-based seed water-retention sowing method capable of effectively relieving the dependence of crop seed sowing on soil moisture and suitable for dry land sowing.

To achieve the above objectives, the technical solution applied to the present invention is a dry land-based seed water-retention sowing method, where the method is implemented according to the following steps of:
S1, production of an interlayered non-woven fabric: using a non-woven fabric having a thickness of 0.1-1 mm, paving a first non-woven fabric, and paving a 30-60 meshed polyacrylamide water-retaining agent above the first non-woven uniformly, and then paving a second non-woven fabric on the surface of the polyacrylamide water-retaining agent, arranging grid double stitches on the two non-woven fabrics for stitching to form the interlayered non-woven fabric;
S2, production of seed water-retention barrels: cutting along the middle position of vertical double stitches of the interlayered non-woven fabric to form a plurality of interlayered non-woven strips, and then folding the interlayered non-woven strips in half, and stitching the folded two ends to form the water-retention barrels;
S3, production of water-retention sleeves: cutting the water-retention barrels along the middle position of transverse double stitches to form a plurality of water-retention sleeves having a thickness of 0.8-10 cm;
S4, seed sleeving: placing seeds into the water-retention sleeves, respectively, where plumule of each seed is upward placed into each water-retention sleeve along the bottom opening of each water-retention sleeve;
S5, seed sowing: soaking the sleeved seeds into water for 5-30 min, and then sowing the seeds.

Preferably, the seed water-retention barrels have a diameter of 0.5-8 cm.

Preferably, the non-woven fabric is a water-absorbing non-woven fabric.

Compared with the prior art, the present invention has the following technical effects: in this present invention, non-woven fabric and a water-retaining agent are used to produce seed water-retention sleeves, and seeds are placed into the water-retention sleeves and then sown; in this way, the seeds do not rely on soil moisture simply within 15-30 d after sowing, but make use of moisture absorbed and carried by the water-retaining agent during sowing; therefore, the method of the present invention can effectively relieve the dependence of crop seed sowing on soil moisture, ensure seed sowing in drought conditions and make seeds seedling emergence ahead of 1-3 d, thereby improving the seedling emergence rate of seeds by 6-31% and increasing the yield by 7%-70%. The method of the present invention can be widely applied to the seed sowing of maize, beans (Glycine max, Pisum sativum, mung bean, Vigna angularis, Vicia faba, Vigna sinensis, Phaseolus vulgaris, Lens culinaris, Vigna umbellata, Cicer arietinum, etc.), yams and taroes (Dioscorea esculenta, Solanum tuberosum, Manihot esculenta, Pachyrhizus erosus, Dioscorea polystachya (Dioscorea opposita), Colocasia esculenta, Helianthus tuberosus, Canna edulis Ker, etc.), peanut and the like.

### DETAILED DESCRIPTION OF THE EMBODIMENTS

To make the technical problems to be solved by the present invention, technical solution and beneficial effects more clearly and apparently, the present invention will be further described in detail with reference to embodiments below. It should be understood that detailed embodiments described here are merely used to explain the present invention, but are not construed as limiting the present invention.

### Example I

A dry land-based maize seed water-retention sowing method was implemented according to the following steps:
S1, production of an interlayered non-woven fabric: a non-woven fabric having a thickness of 0.1-1 mm was used, where the non-woven fabric was a water-absorbing non-woven fabric and mainly composed of 80%-90% polypropylene and 10%-20% LT-Q-216 hydrophilic agent; the first non-woven fabric was paved, and then a 30-60 meshed polyacrylamide water-retaining agent was paved above the first non-woven uniformly, then a second non-woven fabric was paved on the surface of the polyacrylamide water-retaining agent, grid double stitches were arranged on the two non-woven fabrics for stitching to form the interlayered non-woven fabric;
S2, production of seed water-retention barrels: a plurality of interlayered non-woven strips were formed by cutting along the middle position of vertical double stitches of the interlayered non-woven fabric, and then the interlayered non-woven strips were folded in half, and the folded two ends were stitched to form the water-retention barrels having a diameter of 0.8-1.5 cm;
S3, production of water-retention sleeves: the water-retention barrels were cut retention sleeves having a thickness of 0.8-2 cm;
S4, seed sleeving: seeds were placed into the water-retention sleeves, sleeve along the bottom opening of each water-retention sleeve;
S5, seed sowing: the sleeved seeds were soaked into water for 5-30 min, and then sown.

The method enables the maize seeds to emerge seedlings within 5-18 d ahead of 1-3 d relative to conventional methods, which improves the seedling emergence rate of seeds by 10-30% and increases the yield by 10%-15%.

### Example II

A dry land-based Phaseolus vulgaris seed water-retention sowing method was implemented according to the following steps:
S1, production of an interlayered non-woven fabric: a non-woven fabric having a thickness of 0.1-1 mm was used, where the non-woven fabric was a water-absorbing non-woven fabric and mainly composed of 80%-90% polypropylene and 10%-20% LT-Q-216 hydrophilic agent; the first non-woven fabric was paved, and then a 30-60 meshed polyacrylamide water-retaining agent was paved above the first non-woven uniformly, then a second non-woven fabric was paved on the surface of the polyacrylamide water-retaining agent, grid double stitches were arranged on the two non-woven fabrics for stitching to form the interlayered non-woven fabric;
S2, production of seed water-retention barrels: a plurality of interlayered non-woven strips were formed by cutting along the middle position of vertical double stitches of the interlayered non-woven fabric, and then the interlayered non-woven strips were folded in half, and the folded two ends were stitched to form the water-retention barrels having a diameter of 0.5-2.5 cm;
S3, production of water-retention sleeves: the water-retention barrels were cut retention sleeves having a thickness of 0.8-2.5 cm;
S4, seed sleeving: seeds were placed into the water-retention sleeves, sleeve along the bottom opening of each water-retention sleeve;
S5, seed sowing: the sleeved seeds were soaked into water for 5-30 min, and then sown.

The method enables the Phaseolus vulgaris seeds to emerge seedlings within 6-13 d ahead of 1-2 d relative to conventional methods, which improves the seedling emergence rate of seeds by 12-28% and increases the yield by 7%-15%.

### Example III

A dry land-based Solanum tuberosum tuber water-retention sowing method was implemented according to the following steps:
S1, production of an interlayered non-woven fabric: a non-woven fabric having a thickness of 0.1-1 mm was used, where the non-woven fabric was a water-absorbing non-woven fabric and mainly composed of 80%-90% polypropylene and 10%-20% LT-Q-216 hydrophilic agent; the first non-woven fabric was paved, and then a 30-60 meshed polyacrylamide water-retaining agent was paved above the first non-woven uniformly, then a second non-woven fabric was paved on the surface of the polyacrylamide water-retaining agent, grid double stitches were arranged on the two non-woven fabrics for stitching to form the interlayered non-woven fabric;
S2, production of seed water-retention barrels: a plurality of interlayered non-woven strips were formed by cutting along the middle position of vertical double stitches of the interlayered non-woven fabric, and then the interlayered non-woven strips were folded in half, and the folded two ends were stitched to form the water-retention barrels having a diameter of 5-8 cm;
S3, production of water-retention sleeves: the water-retention barrels were cut retention sleeves having a thickness of 5-10 cm;
S4, seed sleeving: seeds were placed into the water-retention sleeves, sleeve along the bottom opening of each water-retention sleeve;
S5, seed sowing: the sleeved seeds were soaked into water for 5-30 min, and then sown.

The method enables the Solanum tuberosum tuber to emerge seedlings within 18-28 d ahead of 1-2 d relative to conventional methods, which improves the seedling emergence rate of seeds by 13-31% and increases the yield by 50%-70%.

### Example IV

A dry land-based peanut seed water-retention sowing method was implemented according to the following steps:
S1, production of an interlayered non-woven fabric: a non-woven fabric having a thickness of 0.1-1 mm was used, where the non-woven fabric was a water-absorbing non-woven fabric and mainly composed of 80%-90% polypropylene and 10%-20% LT-Q-216 hydrophilic agent; the first non-woven fabric was paved, and then a 30-60 meshed polyacrylamide water-retaining agent was paved above the first non-woven uniformly, then a second non-woven fabric was paved on the surface of the polyacrylamide water-retaining agent, grid double stitches were arranged on the two non-woven fabrics for stitching to form the interlayered non-woven fabric;
S2, production of seed water-retention barrels: a plurality of interlayered non-woven strips were formed by cutting along the middle position of vertical double stitches of the interlayered non-woven fabric, and then the interlayered non-woven strips were folded in half, and the folded two ends were stitched to form the water-retention barrels having a diameter of 0.8-2 cm;

S3, production of water-retention sleeves: the water-retention barrels were cut along the middle position of transverse double stitches to form a plurality of water-retention sleeves having a thickness of 1-2 cm;
S4, seed sleeving: seeds were placed into the water-retention sleeves, sleeve along the bottom opening of each water-retention sleeve;
S5, seed sowing: the sleeved seeds were soaked into water for 5-30 min, and then sown.

The method enables the peanut seeds to emerge seedlings within 4-7 d ahead of 1-2 d relative to conventional methods, which improves the seedling emergence rate of seeds by 6-10% and increases the yield by 15%-23%.

What is described above are merely preferred embodiments but are not construed as limiting the present invention. Any amendment, equivalent replacement, improvement and the like made within the spirit and principle of the present invention shall fall within the scope of the present invention.

What is claimed is:

1. A dry land-based seed water-retention sowing method, wherein the method is implemented according to the following steps of:
S1, production of an interlayered non-woven fabric: using a non-woven fabric having a thickness of 0.1-1 mm, paving a first non-woven fabric, and paving a 30-60 meshed polyacrylamide water-retaining agent above the first non-woven uniformly, and then paving a second non-woven fabric on the surface of the polyacrylamide water-retaining agent, arranging grid double stitches on the two non-woven fabrics for stitching to form the interlayered non-woven fabric;
S2, production of seed water-retention barrels: cutting along the middle position of vertical double stitches of the interlayered non-woven fabric to form a plurality of interlayered non-woven strips, and then folding the interlayered non-woven strips in half, and stitching the folded two ends to form the water-retention barrels;
S3, production of water-retention sleeves: cutting the water-retention barrels along the middle position of transverse double stitches to form a plurality of water-retention sleeves having a thickness of 0.8-10 cm;
S4, seed sleeving: placing seeds into the water-retention sleeves, respectively, wherein plumule of each seed is upward placed into each water-retention sleeve along the bottom opening of each water-retention sleeve;
S5, seed sowing: soaking the sleeved seeds into water for 15-30 min, and then sowing the seeds.

2. The dry land-based seed water-retention sowing method according to claim 1, wherein the seed water-retention barrels have a diameter of 0.5-8 cm.

3. The dry land-based seed water-retention sowing method according to claim 1, wherein the non-woven fabric is a water-absorbing non-woven fabric.
